(19) United States
(12) Patent Application Publication
(10) Pub. No.: US 2025/0236128 A1
(43) Pub. Date: Jul. 24, 2025

(54) MEDIUM TRANSPORT APPARATUS AND PRINTING APPARATUS

(71) Applicant: SEIKO EPSON CORPORATION, Tokyo (JP)

(72) Inventor: Ayato TAMURA, AZUMINO-SHI (JP)

(21) Appl. No.: 19/033,803

(22) Filed: Jan. 22, 2025

(30) Foreign Application Priority Data
Jan. 24, 2024 (JP) 2024-008542

(51) Int. Cl. B41J 15/16; B41J 11/00; B41J 15/02; B41J 15/04

(52) U.S. Cl. CPC B41J 15/165; B41J 11/0022; B41J 15/02; B41J 15/048

(57) ABSTRACT

A medium transport apparatus includes a medium support portion that supports a medium to be transported, a winding portion that winds the medium; a tension bar that applies tension to the medium between the medium support portion and the winding portion, an arm portion that supports the tension bar at one end thereof, a pivoting portion that pivotably supports the other end of the arm portion, and a power source that applies a force for pivoting the arm portion, wherein the power source applies the force to the arm portion such that an amount of change in the force has a sign opposite to a sign of an amount of change in a moment due to weights of the tension bar and the arm portion.

The present application is based on, and claims priority from JP Application Serial Number 2024-008542, filed Jan. 24, 2024, the disclosure of which is hereby incorporated by reference herein in its entirety.

### BACKGROUND

### 1. Technical Field

The present disclosure relates to a medium transport apparatus and a printing apparatus.

### 2. Related Art

In the related art, medium transport apparatuses that wind a continuous form medium such as roll paper around a roll body are known. Some of such apparatuses include a tension bar in order to improve the winding accuracy of the medium. For example, JP-A-2007-268824 discloses a printing apparatus that applies tension to a medium using swinging of a swing arm.

However, the apparatus described in JP-A-2007-268824 has a problem in that the tension applied to the medium easily fluctuates. Specifically, when the swing arm swings due to its own weight, roll paper which is a medium is bent in a curve and tension is applied. That is, a strength of the tension to be applied depends on masses of the swing arm and a tension bar. Therefore, a degree of bending of the roll paper changes depending on a position of the swing arm in a swing process, and the tension easily fluctuates. When the tension fluctuates, winding accuracy may decrease and a problem such as winding deviation is likely to occur. That is, a medium transport apparatus that reduces fluctuation in tension applied to the medium is required.

### SUMMARY

A medium transport apparatus includes a medium support portion configured to support a medium to be transported, a winding portion configured to wind the medium, a tension bar configured to apply tension to the medium between the medium support portion and the winding portion, an arm portion configured to support the tension bar at one end thereof, a pivoting portion configured to pivotably support the other end of the arm portion, and a power source configured to apply a force for pivoting the arm portion, wherein the power source applies the force to the arm portion such that an amount of change in the force has a sign opposite to a sign of an amount of change in a moment due to weights of the tension bar and the arm portion.

A printing apparatus includes a printing unit configured to perform printing on a medium, a medium support portion configured to support the medium to be transported, a winding portion configured to wind the medium, a tension bar configured to apply tension to the medium between the medium support portion and the winding portion, an arm portion configured to support the tension bar at one end thereof, a pivoting portion configured to pivotably support the other end of the arm portion, and a power source configured to apply a force for pivoting the arm portion, wherein the power source applies the force to the arm portion such that an amount of change in the force has a sign opposite to a sign of an amount of change in a moment due to weights of the tension bar and the arm portion.

### BRIEF DESCRIPTION OF THE DRAWINGS

FIG. 1 is a schematic diagram illustrating a configuration of a printing apparatus according to a first embodiment.

FIG. 2 is a perspective view illustrating an exterior of the printing apparatus.

FIG. 3 is a side view illustrating a configuration of a power source, a pivoting portion, an arm portion, and the like.

FIG. 4 is a perspective view illustrating a disposition of the power source, the pivoting portion, the arm portion, and the like.

FIG. 5 is a graph illustrating a relationship between an operation angle of the arm portion and various moments.

FIG. 6 is a schematic diagram illustrating a configuration of a pivoting portion, a power source, and the like according to a second embodiment.

FIG. 7 is a graph illustrating a relationship between an operation angle of the arm portion and various moments.

### DESCRIPTION OF EMBODIMENTS

In embodiments to be described below, a medium transport apparatus and a printing apparatus including the medium transport apparatus will be described as examples with reference to the drawings. The printing apparatus according to the following embodiment is a large format printer that performs printing on a continuous form sheet. The medium transport apparatus of the present disclosure is not limited to being included in the printing apparatus, and the printing apparatus of the present disclosure is not limited to the following configurations.

In the following drawings, X, Y, and Z axes are provided as mutually orthogonal coordinate axes, a direction indicated by each arrow is a + direction, and a direction opposite to the + direction is a − direction. When the printing apparatus is installed on a horizontal surface, a −Z direction is a vertical direction. In the following description, a +Z direction is a “downward direction” and a −Z direction is an “upward direction”. In the following figures, sizes of respective members may be different from actual sizes for the convenience of illustration.

### 1. First Embodiment

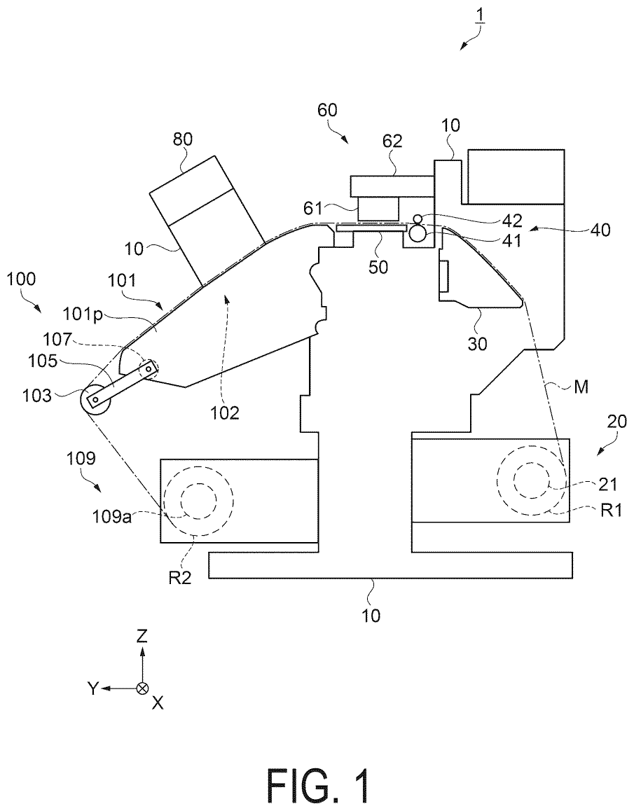

As illustrated in FIG. 1, a printing apparatus 1 according to the present embodiment includes a structural member 10, a feeding unit 20, medium support members 30 and 50, a transport unit 40, a printing unit 60, an air blowing unit 80, a medium transport apparatus 100, and a housing (not illustrated). Further, the printing apparatus 1 includes a control unit (not illustrated). The control unit integrally controls operations of respective configurations of the printing apparatus 1 including the medium transport apparatus 100. The medium transport apparatus 100 is an example of the medium transport apparatus of the present disclosure.

In FIG. 1, for convenience of illustration, a housing that accommodates the printing unit 60 and the like is omitted. In description of FIG. 1 below, a state viewed from a −X direction will be described unless otherwise specified.

The printing apparatus 1 manufactures a printed material by attaching ink to a medium M which is a continuous form sheet. In the printing apparatus 1, the medium M is fed from a roll body R1, which is an original sheet, to form a printed material, and the printed material is wound to form a roll body R2.

The control unit includes hardware such as a central processing unit (CPU), a read only memory (ROM), and a random access memory (RAM). The control unit controls the printing apparatus 1 by executing a predetermined control program using the CPU. The ROM is a nonvolatile storage device, and stores a control program executed by the CPU and data processed by the control program. The RAM is used as a work area of the CPU. The CPU loads the control program read from the ROM or the like into the RAM, and executes the loaded control program to control the printing apparatus 1.

The path along which the medium M moves from being fed from the roll body R1 to being wound as the roll body R2 is called a transport path. In FIG. 1, the transport path is indicated by a one-dot chain line. In the transport path, an original sheet side of the medium M is also referred to as an upstream, and the side to which the medium M and a printed material travel is also referred to as a downstream. In the transport path, the feeding unit 20, the medium support member 30, the transport unit 40, the medium support member 50, the printing unit 60, the medium transport apparatus 100, and the air blowing unit 80 are disposed in this order from the upstream to the downstream. In the transport path, a direction in which the medium M travels from the upstream to the downstream is also referred to as a transport direction.

The structural member 10 is a frame that supports each component of the printing apparatus 1. The structural member 10 is formed by a plurality of sheet metal members, tubular members, and the like being assembled. In the structural member 10, a caster, an installation member, and the like may be disposed in a portion that comes into contact with a floor at a lower side.

The feeding unit 20 includes a roll body holding portion 21. The feeding unit 20 is disposed in a −Y direction under the printing apparatus 1. The roll body holding portion 21 rotatably supports the roll body R1 about a shaft along an X-axis. The medium M is pulled by the transport unit 40 and is fed and supplied downstream from the roll body R1. The roll body R1 can be attached to and detached from the printing apparatus 1. The medium M is transported substantially upward from the roll body holding portion 21 by the transport unit 40 and proceeds to the medium support member 30.

The medium M is appropriately selected according to a type of ink to be attached to the medium M, the use of the printed material, and the like. In the printing apparatus 1, since so-called soft solvent ink is used as the ink, a sheet made of polyvinyl chloride or the like is applied as the medium M.

The medium support member 30 has an approximately arc-shaped curved surface and supports the medium M to be transported. The transport direction of the medium M is changed from a substantially upward direction to a substantially +Y direction due to the curved surface of the medium support member 30. The medium M is transported while sliding in contact with the curved surface of the medium support member 30. The medium M proceeds from the medium support member 30 to the transport unit 40.

Although not illustrated, the medium support member 30 includes an electric heater that heats the medium M. The electric heater heats the medium M in advance before the ink is attached. Accordingly, fixability, solubility, and the like of the ink with respect to the medium M are improved.

The transport unit 40 includes transport rollers 41 and 42. The transport rollers 41 and 42 form a pair, and side surfaces thereof are in contact with each other. The transport roller 41 is disposed under the transport path, and the transport roller 42 is disposed above the transport path. The transport rollers 41 and 42 rotate about a shaft along the X-axis.

The transport roller 41 is rotated by a driving motor (not illustrated) being driven. The transport roller 42 is a driven roller and rotates in a direction opposite to the transport roller 41 due to the rotation of the transport roller 41. When the transport roller 41 rotates counterclockwise, the transport roller 42 rotates clockwise. Accordingly, the medium M is sandwiched between the transport rollers 41 and 42 and transported downstream. The medium M proceeds to the medium support member 50.

The medium support member 50 is a member constituting a so-called platen. An upper surface of the medium support member 50 extends along an XY plane and supports the medium M. In the medium support member 50, the transport direction of the medium M is the +Y direction. A surface of the medium M facing upward is a printing surface.

Although not illustrated, the medium support member 50 includes an electric heater that heats the medium M. The electric heater heats the medium M when the ink is attached. Accordingly, the fixability, solubility, and the like of the ink with respect to the medium M are improved, and a volatile component such as a solvent included in the ink is easily volatilized.

The printing unit 60 performs printing on the medium M. The printing unit 60 includes a head 61 and a carriage 62. The printing unit 60 is disposed above the medium support member 50. The carriage 62 is supported above the structural member 10 to be able to reciprocate along the X-axis. The reciprocating movement is driven by a carriage motor (not shown). The carriage 62 supports the head 61 above the medium support member 50.

The head 61 causes ink to adhere to the printing surface of the medium M supported on the upper surface of the medium support member 50. The head 61 reciprocates together with the carriage 62 along the X axis in a range including a region facing the medium support member 50 in an up-down direction.

Although not illustrated, a nozzle surface is disposed on a surface of the head 61 that faces downward. A plurality of nozzle arrays are provided on the nozzle surface. Each nozzle array includes a plurality of nozzles that eject ink. For example, ink of each color such as black, cyan, yellow, and magenta is individually supplied to each nozzle array from an ink container (not shown). Each color ink is ejected from each nozzle array toward the printing surface of the medium M.

The ink applied to the printing apparatus 1 is the soft solvent ink as described above. The soft solvent ink is, for example, a solvent ink that does not contain intentionally added water and contains a glycol ether-based solvent, a lactone-based solvent, or the like as a main solvent. The ink ejected by the head 61 may include a treatment liquid, clear ink not containing a color material, and the like.

In the medium support member 50, the head 61 is reciprocated along the X axis together with the carriage 62 while the medium M is transported in the +Y direction. In this case, an image such as a picture, a photograph, text, or a pattern is printed on the medium M by attaching the ink to the printing surface of the medium M at an arbitrary timing. The medium M on which printing has been performed is pulled by the medium transport apparatus 100 and proceeds to the medium transport apparatus 100 and the air blowing unit 80 on the downstream.

The medium transport apparatus 100 includes a medium support portion 101, a heating unit 102, a tension bar 103, an arm portion 105, a pivoting portion 107, a winding portion 109, and a power source 106 to be described below.

Each configuration of the medium transport apparatus 100 is supported by the structural member 10 and is disposed in the +Y direction of the printing apparatus 1. In the medium transport apparatus 100, the medium support portion 101, the tension bar 103, and the winding portion 109 are disposed in the order described above in the transport direction.

The medium support portion 101 has a curved surface as a surface for supporting the medium M and supports the medium M to be transported. A curved surface of the medium support portion 101 faces substantially upward in the medium support portion 101. The medium M is transported while sliding in contact with the curved surface of the medium support portion 101. In a direction along the X axis, a length of the curved surface of the medium support portion 101 is larger than that of the medium M. The transport direction of the medium M is changed from the +Y direction to the +Y direction and slightly downward due to the curved surface of the medium support portion 101.

The medium support portion 101 includes a pair of sidewalls 101p. The sidewalls 101p are disposed at an end portion in the +X direction and an end portion in the-X direction of the medium support portion 101, respectively. Each of the sidewalls 101p is a substantially plate-shaped member and is formed of, for example, a sheet metal. Each sidewall 101p includes a surface that is along a YZ plane and intersects the curved surface of the medium support portion 101.

The medium support portion 101 includes a heating unit 102. The heating unit 102 is an electric heater. The heating unit 102 heats the medium M supported by the curved surface of the medium support portion 101. The heating unit 102 is disposed on the inner side of the curved surface of the medium support portion 101. The heating unit 102 promotes volatilization of a volatile component included in the ink attached to the medium M through heating. Accordingly, when the medium M is wound around the roll body R2 by the winding portion 109, it is possible to prevent ink components from adhering to other parts.

The air blowing unit 80 blows air to the printing surface of the medium M to assist in the volatilization of the volatile component. The air blowing unit 80 is supported by the structural member 10 above the transport path of the medium support portion 101. The air blowing unit 80 blows the air to the entire range of the medium M along the X-axis.

Drying of the ink attached to the medium M is promoted due to the heating in the heating unit 102 and the air blowing in the air blowing unit 80. Therefore, it is possible to wind the medium M in the winding portion 109 on the downstream. The medium M is pulled and transported by the winding portion 109 and proceeds to the tension bar 103.

The tension bar 103 applies tension to the medium M between the medium support portion 101 and the winding portion 109 in the transport path. The tension bar 103 is a substantially cylindrical member, and a longitudinal direction of a cylinder is disposed along the X axis. The end portion of the tension bar 103 in a −X direction and the end portion thereof in the +X direction are supported by the arm portions 105, respectively. The tension bar 103 is supported by a pair of arm portions 105 and protrudes slightly downward in the +Y direction from the medium support portion 101.

In a configuration in which the tension bar 103 is not provided, the medium M proceeds from an end portion of the medium support portion 101 in the +Y direction to the winding portion 109 on the substantially lower side. On the other hand, in the printing apparatus 1, the tension bar 103 protrudes downward in the slightly +Y direction from the medium support portion 101. Therefore, the medium M is transported while being pressed in the substantially +Y direction by the tension bar 103. Accordingly, the medium M is wound by the winding portion 109 while the tension is applied thereto.

A surface corresponding to a side surface of the cylinder of the tension bar 103 is formed smoothly with relatively low frictional resistance. Therefore, the medium M slides on the side surface of the tension bar 103 while tension is applied thereto. The side surface of the cylinder of the tension bar 103 may be covered with a sheet-like member not to come in direct contact with the medium M. The tension bar 103 does not rotate with respect to the arm portion 105.

Each arm portion 105 is a substantially rod-shaped member. In a state where the tension bar 103 functions, each arm portion 105 supports the tension bar 103 at one end in the substantially +Y direction. The other end portion of each arm portion 105 in the substantially −Y direction is pivotably supported by the pivoting portion 107.

In a plan view from above, a length which is a distance between one end and the other end of each arm portion 105 is smaller than a length along the transport direction of the medium support portion 101. Therefore, the arm portion 105 and the like are relatively small.

The pivoting portion 107 is disposed to correspond to each of the arm portions 105. Specifically, the pivoting portion 107 is provided on the sidewall 101p in the +X direction and the sidewall 101p in the −X direction in the medium support portion 101. Therefore, the pivoting portions 107 and the medium M are difficult to interfere with each other, and it is possible to reduce a size of the medium transport apparatus 100.

Here, the pivoting portion 107 is not limited to being disposed on the sidewall 101p. The pivoting portion 107 may be disposed on the structural member 10. Specifically, for example, the pivoting portion 107 may be disposed closer to the lower side of the structural member 10. In this case, the arm portion 105 is extended in order to apply tension to the medium M between the medium support portion 101 and the winding portion 109.

Each pivoting portion 107 pivots clockwise and counterclockwise about the vicinity of the other end portion of the arm portion 105 as a rotation center due to the force applied by the power source 106 to be described below. One end portion of each of the arm portions 105 pivots clockwise and counterclockwise while supporting the tension bar 103. Accordingly, a position of the tension bar 103, in particular, a protrusion distance in the +Y direction from the medium support portion 101 is changed, and the strength of the tension applied to the medium M is adjusted. Specifically, when the tension bar 103 pivots in the clockwise direction, the protrusion distance of the tension bar 103 in the +Y direction from the medium support portion 101 increases, and the medium M is pressed in the +Y direction and strong tension is applied. Further, when the tension bar 103 pivots counterclockwise, the protrusion distance of the tension bar 103 in the +Y direction from the medium support portion 101 decreases, a force with which the medium M is pressed in the +Y direction weakens, and the applied tension is reduced.

Each pivoting portion 107 is provided at a position closer to an end portion in the +Y direction which is a downstream end of the medium support portion 101 than an end in the −Y direction which is an upstream end portion of the medium support portion 101 with respect to the transport direction of the medium M. Accordingly, a length of the arm portion 105 is shortened compared to that when each pivoting portion 107 is provided close to the upstream end portion of the medium support portion 101.

The transport direction of the medium M is changed from a downward direction in the +Y direction to a downward direction in the −Y direction by the tension bar 103. The medium M advances to the winding portion 109 via the tension bar 103.

The winding portion 109 winds the medium M around the roll body R2. The winding portion 109 includes a roll body holding portion 109a. The winding portion 109 is disposed in the +Y direction under the printing apparatus 1. The roll body holding portion 109a rotates counterclockwise due to rotational driving of a driving motor (not illustrated) and winds the medium M as the roll body R2. In this case, the roll body R2 rotates about a shaft along the X-axis.

When the medium M is wound around the roll body R2, the winding accuracy is improved due to the tension applied by the tension bar 103. Therefore, a positional deviation of both ends of the medium M along the X-axis is reduced, and the roll body R2 in which both the ends are relatively aligned is obtained. Further, a gap between the stacked media M is reduced by the applied tension, and a dense roll body R2 is obtained. The strength of the tension applied to the medium M has an appropriate range. The tension is appropriately set according to a type, size, and the like of the medium M.

As described above, the medium M which is a printed material becomes the roll body R2. The roll body R2 can be removed in the substantially +Y direction from the printing apparatus 1.

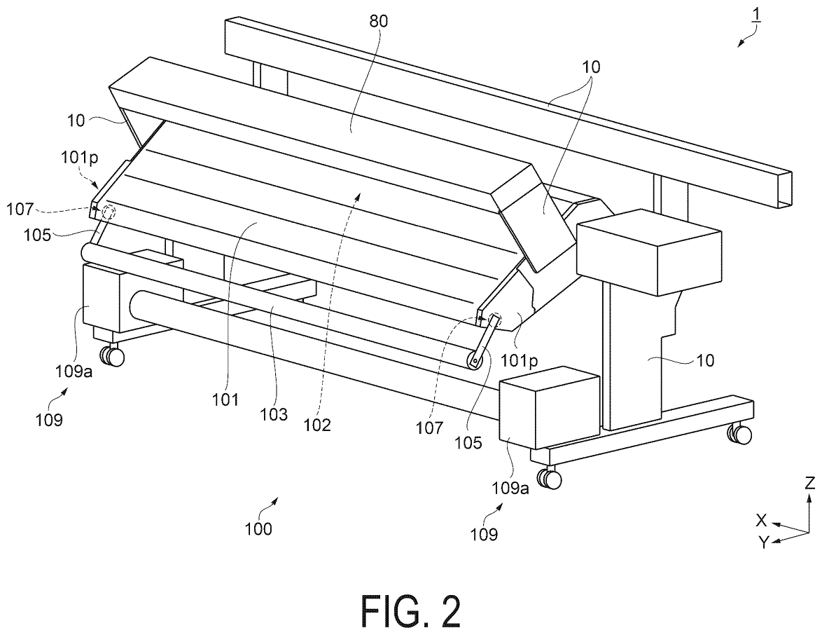

As illustrated in FIG. 2, the sidewalls 101p are disposed at the end portion in the −X direction and the end portion in the +X direction of the medium support portion 101, respectively. The pivoting portion 107, the arm portion 105, and the power source 106 (not shown) are disposed on each sidewall 101p. Both the ends of the tension bar 103 in the direction along the X-axis are supported by the arm portions 105. In FIG. 2, illustration of a housing of the printing apparatus 1 and other components including the printing unit 60 is omitted.

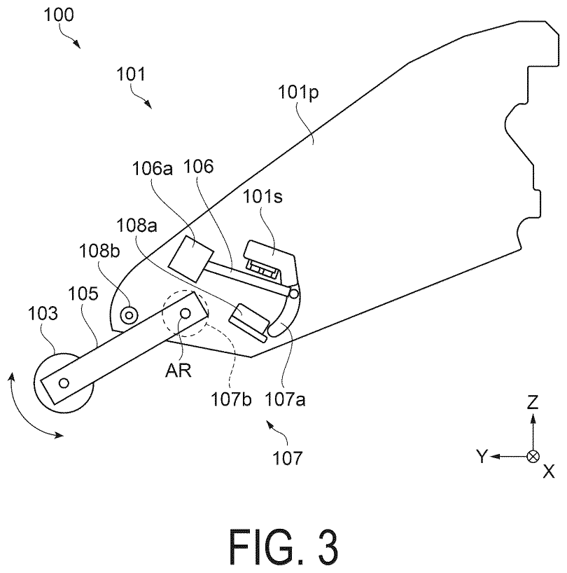

As illustrated in FIG. 3, the power source 106 is attached to the pivoting portion 107. The pivoting portion 107 includes gears 107a and 107b as reduction gears. FIG. 3 illustrates the sidewall 101p of the medium transport apparatus 100 in the −X direction as viewed from the −X direction. On the sidewall 101p in the +X direction of the medium transport apparatus 100, respective configurations are disposed plane-symmetrically with respect to a surface along the YZ plane.

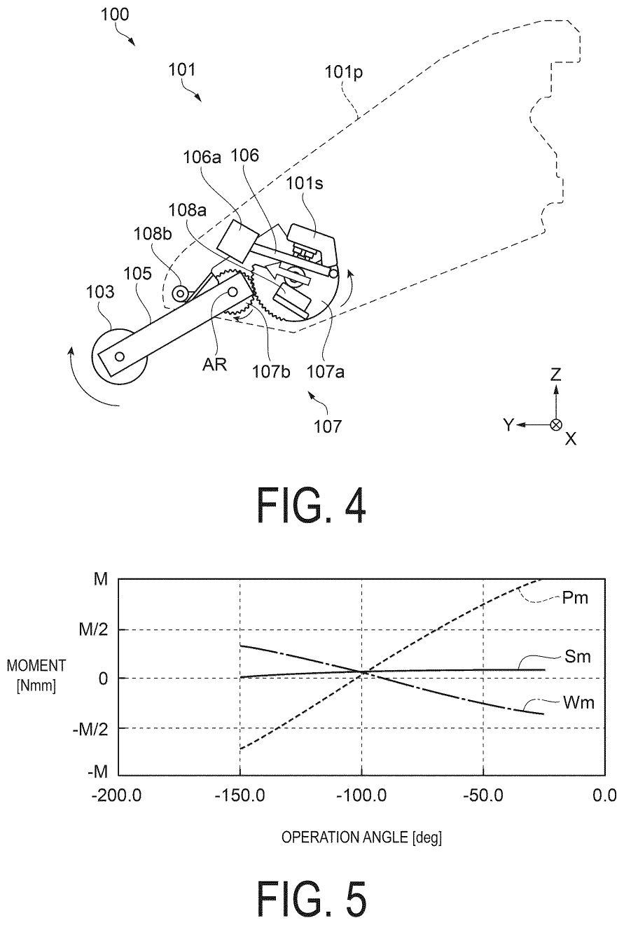

In the following description, a configuration on the-X direction side will be described as a representative example, and description of the configuration on the +X direction side will be omitted. Further, in the following description of FIGS. 3 and 4, a state viewed from the −X direction will be described unless otherwise specified.

The power source 106 applies a force for pivoting the arm portion 105. The power source 106 is disposed on the outer side of the sidewall 101p in the −X direction, that is, on the −X direction side. Therefore, the medium M and the power source 106 are difficult to interfere with each other, and it is possible to reduce the size of the medium transport apparatus 100. Since the power source 106 is disposed outer side the sidewall 101p, the power source 106 can be easily adjusted or replaced.

The power source 106 is a spring. Examples of the spring include a coil spring, a torsion spring, and a plate spring. In the present embodiment, a coil spring is used as the spring of the power source 106. When the spring is used as the power source 106, a pivoting force is applied to the arm portion 105 due to the elasticity of the spring. Therefore, a driving mechanism such as an electric motor is not necessary, and the power source 106 can have a simple and inexpensive configuration.

One end portion of the power source 106 is attached to the gear 107a through an opening (not shown) in the sidewall 101p. The other end portion of the power source 106 is attached to the sidewall 101p via the support member 106a.

The power source 106 is not limited to the spring as long as the power source 106 can apply the pivoting force to the arm portion 105. A damper, a spring, or an electric motor, for example, can be applied to the power source 106.

The gear 107a and the gear 107b are disposed on the inner side of the sidewall 101p in the −X direction, that is, on the +X direction side. When the gear 107a and the gear 107b are disposed on the inner side of the sidewall 101a, the number of members disposed on the outer side of the sidewall 101p can be reduced, and an increase in the length of the medium transport apparatus 100 in the X direction can be curbed. The gears 107a and 107b are pivotably supported by the sidewalls 101p on an axis along the X-axis. The gears 107a and 107b are disposed adjacent to each other in a direction along the Y-axis, and mesh with each other.

The gear 107b penetrates through the sidewall 101p and is directly coupled to the other end portion of the arm portion 105 in the substantially −Y direction in a state where the tension bar 103 functions. The gear 107b is driven due to the pivoting of the gear 107a and pivots about a central shaft AR extending along the X-axis. The arm portion 105 pivots about the central shaft AR as a fulcrum in conjunction with the pivoting of the gear 107b. The tension bar 103 is displaced like a pendulum with the central shaft AR as a fulcrum due to the pivoting of the arm portion 105.

On the outer side of the sidewall 101p in the −X direction, that is, on the −X direction side, a locking member 101s and stoppers 108a and 108b are installed. The locking member 101s is disposed to correspond to the one end portion of the power source 106. The stoppers 108a and 108b are disposed to correspond to the arm portion 105. Members such as the power source 106 disposed on the outer side the sidewall 101p may be covered with a cover.

The locking member 101s abuts against the one end portion of the power source 106 when the gear 107a pivots counterclockwise. Accordingly, further counterclockwise pivoting of the gear 107a is restricted.

The stoppers 108a and 108b restrict pivoting of the arm portion 105 beyond a certain range. To be specific, the stopper 108a comes into contact with the arm portion 105, for example, when the arm portion 105 is greatly pivoted in the counterclockwise direction and the arm portion 105 is stored on the lower side of the medium support portion 101. Accordingly, further counterclockwise pivoting of the arm portion 105 is restricted. For example, a storage operation of the arm portion 105 is performed in a scene in which the roll body R2 (not illustrated) is removed from the printing apparatus 1.

The stopper 108b restricts the clockwise pivoting of the arm portion 105. When the arm portion 105 pivots clockwise, the arm portion 105 and the stopper 108b come into contact with each other. Accordingly, further clockwise pivoting of the arm portion 105 is restricted. FIG. 3 shows a state where the arm portion 105 and the stopper 108b are in contact with each other.

As illustrated in FIG. 4, in the state where the tension bar 103 functions, the power source 106 tends to contract in a direction indicated by a white arrow. Accordingly, the gear 107a is urged to pivot counterclockwise. Since the gear 107a and the gear 107b mesh with each other, a rotational driving force of the gear 107a is transmitted to the gear 107b, and the gear 107b pivots clockwise. In conjunction with the pivoting of the gear 107b, the arm portion 105 pivots clockwise about the central shaft AR as a fulcrum. That is, the power source 106 applies the pivoting force to the arm portion 105 via the gears 107a and 107b which are reduction gears.

In FIG. 4, the arm portion 105 is substantially in contact with the stopper 108b. Although pivoting directions of the gears 107a and 107b or the arm portion 105 are indicated by arrows in order to explain the operation of each configuration, the arm portion 105 does not pivot clockwise from the state illustrated in FIG. 4.

In the state where the tension bar 103 functions, one end of the arm portion 105 in the substantially +Y direction is lifted upward by the arm portion 105 pivoting in the clockwise direction. Therefore, the medium M (not illustrated) is pressed in the substantially +Y direction by the tension bar 103, and tension is applied thereto.

The strength of the tension applied to the medium M is adjusted according to an elastic modulus of the power source 106, a reduction ratio of the gears 107a and 107b, the length of the arm portion 105, masses of the arm portion 105 and the tension bar 103, and the like.

Here, the tension applied to the medium M will be described with reference to FIG. 5. FIG. 5 shows a relationship between the rotation angle of the arm portion 105 and various moments. In FIG. 5, a horizontal axis represents the operation angle [deg] which is the rotation angle of the arm portion 105, and a vertical axis represents a magnitude of the moment [Nmm]. M on the vertical axis is a positive numerical value, and is a numerical value common to FIG. 7 to be described later.

The moment Wm is a moment due to weights of the tension bar 103 and the arm portion 105. The moment Pm is a moment of the force applied by the power source 106. A moment Sm is a combination moment obtained by adding the moment Wm to the moment Pm.

The rotation angle of the arm portion 105 is a rotation angle of the arm portion 105 with the central shaft AR as a fulcrum. For the rotation angle of the arm portion 105, a position corresponding to 9 o'clock is set to 0 degree as a reference, a clockwise direction is set to a positive rotation angle, and a counterclockwise direction is set to a negative rotation angle when the medium transport apparatus 100 is viewed from the −X direction.

In the case of a configuration without a power source, in other words, in a configuration in which the tension is applied to the medium only by the weights of the tension bar and the arm portion, the moment of the tension bar varies depending on the rotation angle of the arm portion.

The tension applied to the medium M is determined by the moment of the tension bar. Therefore, when the moment of the tension bar fluctuates, the tension applied to the medium also fluctuates. The fluctuation in the tension easily degrades the winding accuracy of the medium, and becomes a factor of winding deviation or the like.

On the other hand, the medium transport apparatus 100 reduces the fluctuation in the moment of the tension bar 103 using the power source 106. Specifically, in FIG. 5, the moment Wm varies by M/2 or more when an operation angle of the arm portion 105 in a range from −150 deg to −20 deg. The power source 106 applies the force for pivoting the arm portion 105 such that the amount of change is opposite in sign to an amount of change in the moment Wm due to the weights of the tension bar 103 and the arm portion 105. In FIG. 5, the moment Wm is a negative change amount and the moment Pm is a positive change amount when the operation angle of the arm portion 105 moves from −150 deg to −20 deg. The moment Wm and the moment Pm are amounts of change having opposite signs. At least fluctuation tendencies of the moment Wm and the moment Pm include a line segment in which signs of changes are opposite to each other in a range of the operation angle of the arm portion 105 when the tension bar 103 swings. In the present embodiment, the moment Wm is a negative value, and the tension is applied to the medium M by the power source 106 applying the force. However, the fluctuation in the moment Sm is reduced by adding the moment Pm regardless of whether the moment Wm is the positive value or the negative value.

Specifically, in the medium transport apparatus 100, the moment Sm, which is the combination moment of the moment Wm and the moment Pm, is the moment of the tension bar 103. The moment Pm is out of phase with the moment Wm, and a sign of the change is opposite. The moment Pm acts to cancel the fluctuation in the moment Wm. Therefore, the fluctuation in the moment Sm is minor with respect to the fluctuation in the moment Wm. Accordingly, the fluctuation in the moment of the tension bar 103 is reduced, and the fluctuation in the tension applied to the medium M is reduced.

Further, since the pivoting portion 107 includes the gears 107a and 107b as the reduction gears, it is easy to adjust the moment Pm corresponding to the fluctuation in the moment Wm. Further, when the moment Wm and the moment Pm are adjusted to have an anti-phase relationship, the moment Sm does not fluctuate, and a constant tension can be applied to the medium M. However, even when the moment Wm and the moment Pm are not completely in the opposite phase relationship, it is possible to reduce the fluctuation in the moment Sm and to reduce the fluctuation in the tension applied to the medium M by reversing the sign of the change.

According to the present embodiment, the following effects can be obtained.

It is possible to reduce the fluctuation in the tension applied to the medium M. Specifically, in the present embodiment, the tension applied to the medium M depends on the moment Sm which is obtained by combining the moment Wm with the moment Pm through addition. Since the moment Wm depends on the rotation angle of the arm portion 105, the moment Wm also changes when the rotation angle changes. On the other hand, since the sign of the change in the moment Pm is opposite to that of the moment Wm, the moment Pm curbs the fluctuation in the moment Wm. Therefore, the moment Sm does not fluctuate as much as the moment Wm, and even when the rotation angle of the arm portion 105 changes, the fluctuation in the moment Sm is curbed. Accordingly, even when the rotation angle of the arm portion 105 changes, the fluctuation in the tension applied to the medium M is reduced. Therefore, it is possible to provide the medium transport apparatus 100 and the printing apparatus 1 which reduce the fluctuation in the tension applied to the medium M.

### 2. Second Embodiment

In a printing apparatus and a medium transport apparatus according to the present embodiment, a configuration of the pivoting portion 107 is changed with respect to the printing apparatus 1 and the medium transport apparatus 100 according to the above-described embodiment. Configurations similar to those of the printing apparatus 1 and the medium transport apparatus 100 are denoted by the same reference signs, and redundant description will be omitted.

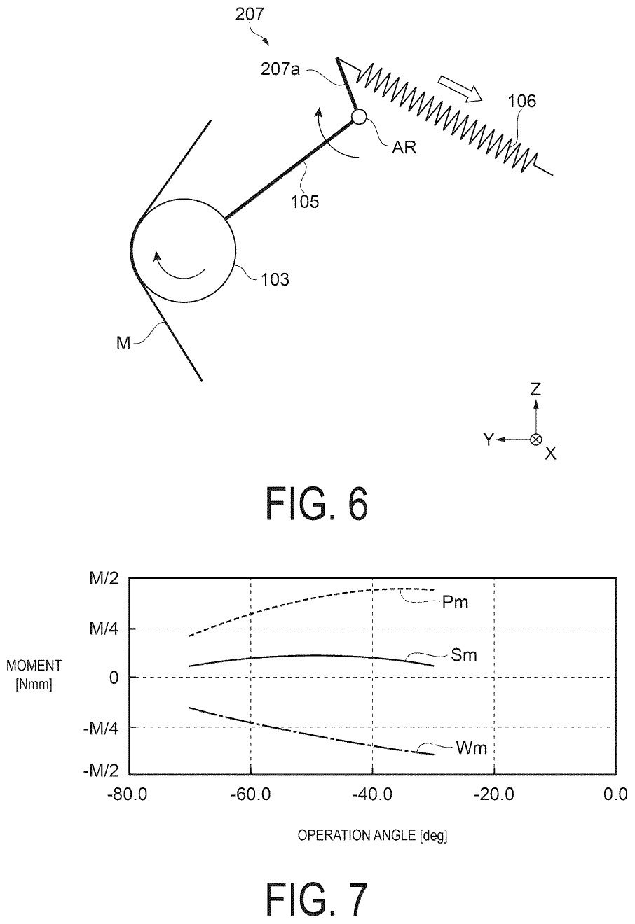

As illustrated in FIG. 6, the medium transport apparatus of the present embodiment includes the tension bar 103, the arm portion 105, a pivoting portion 207, and the power source 106. Further, although not illustrated, the medium transport apparatus according to the present embodiment also includes a medium support portion 101 and a winding portion 109. Further, a state viewed from the −X direction will be described unless otherwise specified in description of FIG. 6.

The medium transport apparatus according to the present embodiment is different from the medium transport apparatus according to the first embodiment in that a pair of pivoting portions 207 are included instead of the pair of pivoting portions 107. Each of the pivoting portions 207 includes a substantially rod-shaped branch portion 207a and does not have a reduction gear.

One end portion which is a root portion of the branch portion 207a is pivotable about the central shaft AR and is directly coupled to the arm portion 105. The pivoting portion 207 pivotably supports the arm portion 105. When the branch portion 207a pivots, the arm portion 105 also pivots in conjunction therewith. An angle between the branch portion 207a and the arm portion 105 is about 100 degrees, and the angle is not changed. The power source 106 is attached to the other end portion which is a tip end portion of the branch portion 207a.

In the power source 106, one end portion is attached to the sidewall 101p (not shown), and the other end portion is attached to the tip portion of the branch portion 207a. In the power source 106, a contraction force acts from the other end portion to the one end portion, and the contraction force applies the pivoting force to the pivoting portion 207.

A biasing force indicated by a white arrow acts on the branch portion 207a due to the power source 106. This force causes the branch portion 207a and the arm portion 105 to rotate in the clockwise direction. The tension bar 103 is displaced to protrude in the substantially +Y direction from the medium support portion 101, and the tension is applied to the medium M.

FIG. 7 is a graph illustrating a relationship between the rotation angle of the arm portion 105 and each moment in the medium transport apparatus according to the present embodiment. A horizontal axis and a vertical axis of the graph are the same variables as in FIG. 5. However, the numerical values and scales are different.

As illustrated in FIG. 7, also in the present embodiment, the moment of the tension bar 103 is the moment Sm which is the combination moment of the moment Wm and the moment Pm. The moment due to the weights of the tension bar 103 and the arm portion 105 is the moment Wm. In FIG. 7, the moment Wm fluctuates by about M/4 in a range from −70 deg to −30 deg of the operation angle of the arm portion 105.

On the other hand, in the present embodiment, the moment Pm due to the power source 106 is added. Since the sign of the change amount of the moment Pm is opposite to that of the moment Wm, the fluctuation in the moment Wm is reduced at the moment Sm. In the present embodiment, the moment Wm is a negative value, and the tension is applied to the medium M by the power source 106 applying the force. However, the fluctuation in the moment Sm is reduced by adding the moment Pm regardless of whether the moment Wm is a positive value or a negative value.

With the present embodiment, it is possible to obtain the effects similar to those of the embodiment described above. Further, a simple configuration without a reduction gear can be achieved.

What is claimed is:

1. A medium transport apparatus comprising:
a medium support portion configured to support a medium to be transported;
a winding portion configured to wind the medium;
a tension bar configured to apply tension to the medium between the medium support portion and the winding portion;
an arm portion configured to support the tension bar at one end thereof;
a pivoting portion configured to pivotably support the other end of the arm portion; and
a power source configured to apply a force for pivoting the arm portion, wherein
the power source applies the force to the arm portion such that an amount of change in the force has a sign opposite to a sign of an amount of change in a moment due to weights of the tension bar and the arm portion.

2. The medium transport apparatus according to claim 1, wherein the power source is a spring.

3. The medium transport apparatus according to claim 1, wherein
the pivoting portion includes a reduction gear, and
the power source applies the force to the arm portion at the reduction gear.

4. The medium transport apparatus according to claim 1, wherein
the medium support portion includes a sidewall including a surface intersecting a surface supporting the medium, and
the pivoting portion is provided at the sidewall.

5. The medium transport apparatus according to claim 4, wherein the power source is disposed on the outer side of the sidewall.

6. A printing apparatus comprising:
a printing unit configured to perform printing on a medium;
a medium support portion configured to support the medium to be transported;
a winding portion configured to wind the medium;
a tension bar configured to apply tension to the medium between the medium support portion and the winding portion; and
an arm portion configured to support the tension bar at one end thereof;
a pivoting portion configured to pivotably support the other end of the arm portion; and
a power source configured to apply a force for pivoting the arm portion, wherein
the power source applies the force to the arm portion such that an amount of change in the force has a sign opposite to a sign of an amount of change in a moment due to weights of the tension bar and the arm portion.
